(19) United States
(12) Patent Application Publication
(10) Pub. No.: US 2010/0015959 A1
(43) Pub. Date: Jan. 21, 2010

(54) CALL GRAPH PROCESSING SYSTEM AND METHOD

(75) Inventor: CHENG-YUAN YU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/494,275

(22) Filed: Jun. 30, 2009

(30) Foreign Application Priority Data
Jul. 18, 2008 (CN) 200810302794.1

(51) Int. Cl. H04M 3/42

(52) U.S. Cl. 455/414.1

(57) ABSTRACT

A computer-based call graph processing system and method dials a phone number of a receiver, and display an option selection to select a call graph on a display of a mobile phone. The system and method further call a radio link protocol to build an IS-95 channel to send a selected call graph to the receiver via the IS-95 channel, and alert the receiver using a default alert mode and display the call graph on a display of the receiver.

### BACKGROUND

1. Technical Field

Embodiments of the present disclosure are related to call management, and particularly to a call graph processing system and method using at least two mobile phones.

2. Description of Related Art

In order to improve amusement of mobile phones, users may store one or more call graph in a mobile phone and preset a particular call graph for a particular phonebook contact of the mobile phone. The call graphs may be an image representing different moods of a user of the mobile phone and may include, for example, a happy image, an angry image, or an impatient image. The mobile phone may display the call graph on a display of the mobile phone when receiving an incoming call from a corresponding contact. However, mobile phones cannot send call graphs to other mobile phone when dialing to other people.

What is needed, therefore, is an improved system and method for processing a call graph to overcome the above-stated problems.

### BRIEF DESCRIPTION OF THE DRAWINGS

FIG. 1 is a block diagram of one embodiment of a first mobile phone and a second mobile phone comprising a call graph processing system.

FIG. 2 is a flowchart of one embodiment of a call graph processing method using the first mobile phone and the second mobile phone.

FIG. 3 is a diagram schematic of a call graph displaying on a display.

### DETAILED DESCRIPTION

All of the processes described may be embodied in, and fully automated via, functional code modules executed by one or more general purpose computers or processors. The code modules may be stored in any type of computer-readable medium or other storage device. Some or all of the methods may alternatively be embodied in specialized computer hardware or electronic apparatus.

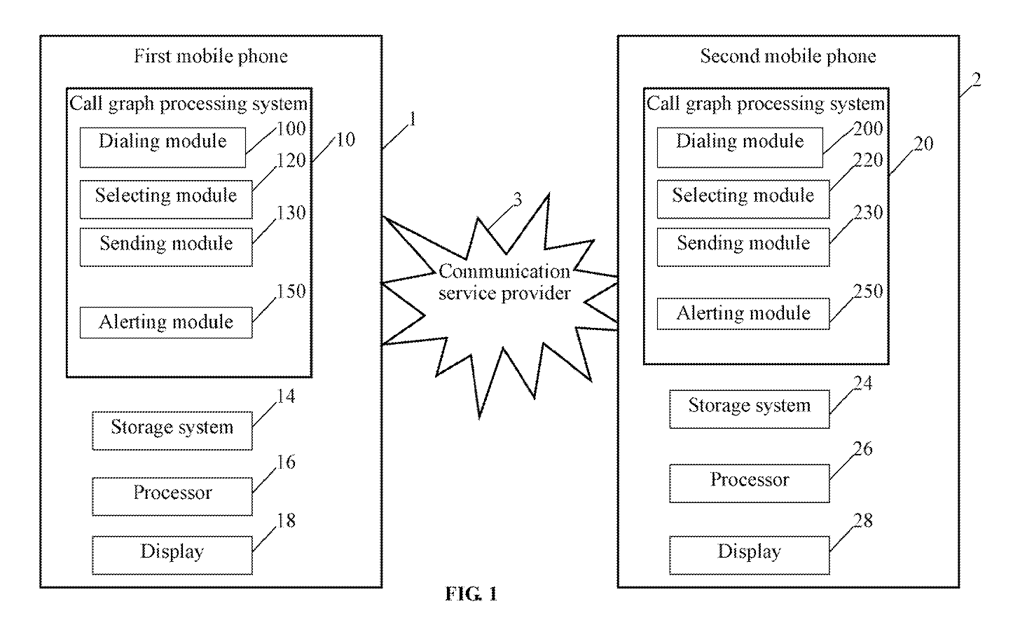

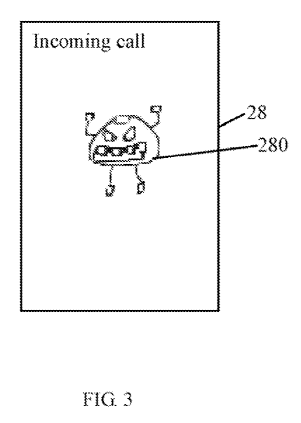

FIG. 1 is a block diagram of one embodiment of a call graph processing system 10 of a first mobile phone 1. For the purpose to describe conveniently, it is supposed that the first mobile phone 1 sends a call graph 280 (shown in FIG. 3) to a second mobile phone 2 when the first mobile phone 1 calls/communicates with the second mobile phone 2 via a communication service provider 3. The communication service provider 3 may be a China Mobile, a China Unicom, or a China Telecom, for example. The second mobile phone 2 receives the call and displays the call graph 280 on a display 28. In one embodiment, the call graph 280 may be an image representing a mood of a caller or a situation of the caller. For example, if a user of the first mobile phone 1 is angry, the user may send a call graph representing angriness to the second mobile phone 2 when communicating with the second mobile phone 2, so as to let the user of the second mobile phone 2 know the user of the first mobile phone 1 is angry.

In one embodiment, the first mobile phone 1 and the second mobile phone 2 may comprise substantially the same components having the same functions, such as the call graph processing systems 10, 20, storage systems 14, 24 and processors 16, 26 correspondingly.

The storage system (14, 24) stores one or more programs, such as computerized codes of the call graph processing system (10, 20), programs of an operating system, and other applications. The storage system (14, 24) further stores at least one call graph representing mood of the user or situation of the user. In one embodiment, the storage system (14, 24) may be an external storage card, such as a smart media card, a secure digital card, a compact flash card, or any other type of memory card, for example. The processor (16, 26) executes programs of the call graph processing system (10, 20) and the other applications, to provide functions of the first mobile phone 1 and the second mobile phone 2.

In one embodiment, the call graph processing systems (10, 20) include dialing modules (100, 200), selecting modules (120, 220), sending modules (130, 230), and alerting modules (150, 250). The mentioned modules may comprise one or more computerized operations to be used to execute one or more operations for the call graph process system (10, 20).

The dialing module 100 of the first mobile phone 1 dials a phone number of the second mobile phone 2. The phone number may be input through a display 18 by the user of the first mobile phone 1 directly or selected from a contact list stored in the storage system 14 of the first mobile phone 1.

The selecting module 120 displays an option selection on the display 18 to the user to select a call graph representing moods or situation of the user of the first mobile phone 1 when dialing the phone number of the second mobile phone 2. The selecting module 120 may display the option selection by outputting a voice recording or displaying a text notice. For example, the voice recording may be “press ‘1’ to select a call graph” or “press ‘2’ to abandon.” The user may select one of the call graphs from the storage system 14 according to the option selection.

The sending module 130 of the mobile phone 1 calls a radio link protocol (RLP) to build an IS-95 channel to send the selected call graph via the communication service provider 3 when the call graph is selected. It is understood that RLP was designed to send large frames of data through an IS-95 channel. For example, if an Internet Protocol (IP) datagram of 500 bytes were to be simply sent in IS-95 frames carrying 20 bytes each, the IP datagram would fill 25 consecutive IS-95 frames. RLP was designed as a link layer protocol which would decrease the error rate of IP traffic to be comparable to the error rate typical of a 10-Base 2 Ethernet channel.

The alerting module 250 of the call graph processing system 20 alerts the user of the second mobile phone 2 that there is an incoming call from the first mobile phone 1 using a default alert mode. At the same time, the alerting module 250 displays the call graph on the display 28 of the second mobile phone 2 if the option selection is to select the call graph. The alert mode may be, but is not limited to, a ring setting, a vibration mode, or a mute mode of the mobile phone (1 or 2). Further, if the option selection is to abandon selecting the call graph, the alerting module 250 only alerts the user using the default alert mode.

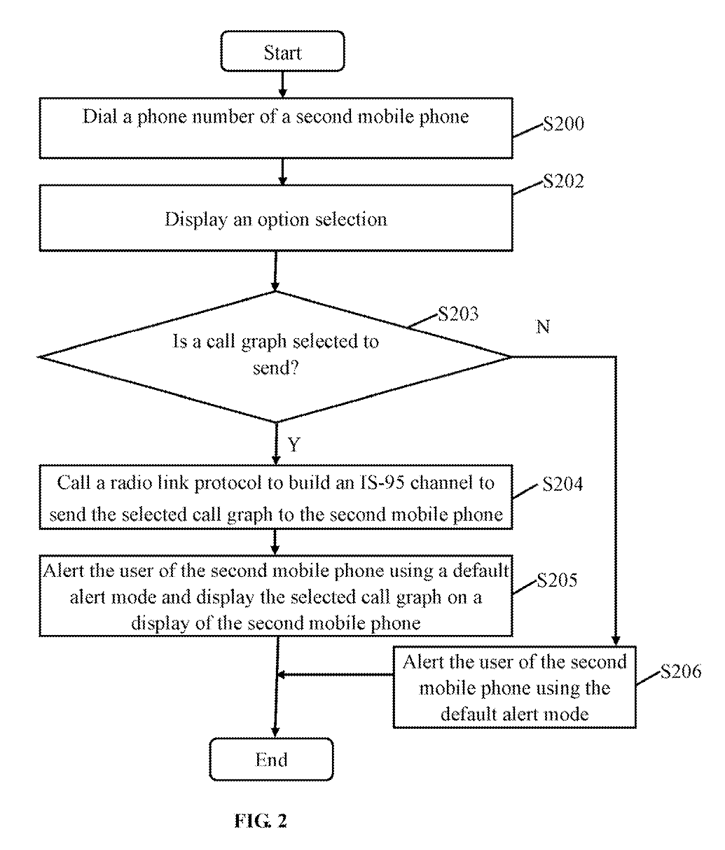

FIG. 2 is a flowchart of one embodiment of a method of processing call graph using the first mobile phone 1 and the second mobile phone 2. Depending on the embodiment, additional blocks may be added, others removed, and the ordering of the blocks may be changed.

In block S200, the dialing module 100 of the first mobile phone 1 dials a phone number of the second mobile phone 2. The phone number may be input through a display 18 by the user of the first mobile phone 1 directly or selected from a contacts list stored in the storage system 14 of the first mobile phone 1.

In block S202, the selecting module 120 displays an option selection when the user of the first mobile phone 1 dials the phone number of the second mobile phone 2 to select a call graph representing moods or situation of the user. The selecting module 120 may display the option selection by outputting a voice recording or displaying a text notice. For example, the voice recording may be “press ‘1’ to select a call graph” or “press ‘2’ to abandon.” The user may select one of the call graphs from the storage system 14 according to the option selection.

In block S203, the selecting module 120 determines if to select a call graph to send according to the option selection by the user of the first mobile phone 1. If a call graph is selected, the procedure goes to block S204. Otherwise, the procedure goes to block S206.

In block S204, the selecting module 120 calls the RLP to build a channel to send the call graph 280 via the communication service provider 3 to the second mobile phone 2 if the call graph 280 is selected.

In block S205, the alerting module 250 alerts the user of the second mobile phone 2 that there is an incoming call from the first mobile phone 1 using the default alert mode. At the same time, the alerting module 250 displays the call graph 280 on the display 28 of the second mobile phone 2 if the option selection is to select the call graph. The alert mode may be, but is not limited to, a ring setting, a vibration mode, or a mute mode of the mobile phone. The user of the second mobile phone 2 may know the mood or the situation of the user of the first mobile phone 1 via the call graph 280.

Otherwise, in block S206, the alerting module 250 alerts the user of the second mobile phone 2 using the default alert mode if the option selection is to abandon selecting the call graph.

Further, the selecting module 220 of the second mobile phone 2 displays an option selection when receives the call, and the user of the second mobile phone 2 may select one call graph to response the current call.

The above embodiments automatically send call graphs representing mood or situation where the user is under, which improves amusement of mobile phone.

It should be emphasized that the above-described inventive embodiments are merely possible examples of implementations, and set forth for a clear understanding of the principles of the present disclosure. Many variations and modifications may be made to the above-described inventive embodiments without departing substantially from the spirit and principles of the present disclosure. All such modifications and variations are intended to be included herein within the scope of this disclosure and the above-described inventive embodiments, and the present disclosure is protected by the following claims.

What is claimed is:

1. A method for processing a call graph of a mobile phone, the method comprising:
dialing a phone number of a receiver;
displaying an option selection on a display of the mobile phone, to select a user-determined call graph of the mobile phone;
calling a radio link protocol to build an IS-95 channel, to send the user-selected call graph of the mobile phone to the receiver via the IS-95 channel; and
alerting the receiver using a default alert mode of the mobile phone and displaying the user-selected call graph on a display of the receiver.

2. The method as claimed in claim 1, further comprising:
alerting the receiver using the default alert mode if the option selection is to abandon selection of the call graph.

3. The method as claimed in claim 1, wherein the receiver is a mobile phone.

4. The method as claimed in claim 1, wherein the default alert mode includes a ring setting, a vibration mode, or a mute mode.

5. A computer-based call graph processing system of a mobile phone, the system comprising:
a storage system;
at least one processor; and
one or more programs stored in the storage system and being executable by the at least one processor, the one or more programs comprising:
a dialing module to dial a phone number of a receiver;
a selecting module to display an option selection on a display of the mobile phone, to select a user-determined call graph of the mobile phone;
a sending module to call a radio link protocol to build an IS-95 channel, to send the user-selected call graph of the mobile phone to the receiver via the IS-95 channel; and
an alerting module to alert the receiver using a default alert mode of the mobile phone and display the user selected call graph on a display of the receiver.

6. The system as claimed in claim 5, wherein the alerting module further alerts the receiver using the default alert mode if the option selection is to abandon selection of the call graph.

7. The system as claimed in claim 5, wherein the receiver is a mobile phone.

8. The system as claimed in claim 5, wherein the default alert mode includes a ring setting, a vibration mode, or a mute mode.

9. The system as claimed in claim 5, wherein the storage system is selected from the group consisting of a smart media card, a secure digital card, and a compact flash card.

10. A storage medium storing a set of instructions, the set of instructions capable of being executed by a processor to perform a call graph processing method of a mobile phone, the method comprising:
dialing a phone number of a receiver;
displaying an option selection on a display of the mobile phone, to select a user-determined call graph of the mobile phone;
calling a radio link protocol to build an IS-95 channel, to send the user-selected call graph of the mobile phone to the receiver via the IS-95 channel; and
alerting the receiver using a default alert mode of the mobile phone and displaying the user-selected call graph on a display of the receiver.

11. The storage medium as claimed in claim 10, wherein the method further comprises:
alerting the receiver using the default alert mode if the option selection is to abandon selection of the call graph.

12. The storage medium as claimed in claim 10, wherein the receiver is a mobile phone.

13. The storage medium as claimed in claim 10, wherein the default alert mode includes a ring setting, a vibration mode, or a mute mode.
